(19) United States
(12) Patent Application Publication
(10) Pub. No.: US 2005/0110711 A1
(43) Pub. Date: May 26, 2005

(54) Method for driving plasma display panel

(76) Inventor: Geun-Yeong Chang, Suwon-si (KR)

Correspondence Address: MCGUIREWOODS, LLP, 1750 TYSONS BLVD, SUITE 1800, MCLEAN, VA, 22102, US

(21) Appl. No.: 10/992,212

(22) Filed: Nov. 19, 2004

(30) Foreign Application Priority Data
Nov. 22, 2003 (KR) 10-2003-0083363

(51) Int. Cl. G09G 3/28

(52) U.S. Cl. 345/60

(57) ABSTRACT

A plasma display panel driving method including processing a video signal to generate a frame, dividing the frame into a plurality of subfields having allocated grayscale weights, and applying a number of sustain pulses for each subfield to the sustain electrode pairs during a sustain period in each subfield. The number of sustain pulses for each subfield is determined such that a brightness produced by applying the number of sustain pulses is linearly proportional to the subfield's allocated grayscale weight.

### CROSS REFERENCE TO RELATED APPLICATION

This application claims the priority of Korean Patent Application No. 10-2003-0083363, filed on Nov. 22, 2003, which is hereby incorporated by reference for all purposes as if fully set forth herein.

### BACKGROUND OF THE INVENTION

1. Field of the Invention

The present invention relates to a method for driving a plasma display panel (PDP), and more particularly, to a PDP driving method providing a number of sustain pulses per subfield with a linear relationship to desired brightness, thereby accurately representing grayscale.

2. Discussion of the Background

FIG. 1 is an internal perspective view showing a typical structure of a surface discharge type triode PDP. Referring to FIG. 1, address electrode lines A_{R1}, A_{G1}, . . . , A_{Gm}, A_{Bm}, dielectric layers 11 and 15, Y-electrode lines Y₁, . . . , Yₙ, X-electrode lines X₁, . . . , Xₙ, phosphor layers 16, partition walls 17, and a protective layer 12 are provided between front and rear glass substrates 10 and 13 of a general surface discharge PDP 1.

The address electrode lines A_{R1} through A_{Bm} are formed on a front surface of the rear glass substrate 13 in a predetermined pattern. A rear dielectric layer 15 covers the address electrode lines A_{R1} through A_{Bm}. The partition walls 17 are formed on the rear dielectric layer 15 to be parallel to, and in between, the address electrode lines A_{R1} through A_{Bm}. These walls define discharge areas of discharge cells and prevent cross talk between discharge cells. The phosphor layers 16 are formed between partition walls 17.

The X-electrode lines X₁ through Xₙ and the Y-electrode lines Y₁ through Yₙ are formed on a rear surface of the front glass substrate 10 to be orthogonal to the address electrode lines A_{R1} through A_{Bm}, and their respective intersections define discharge cells. The X-electrode lines X₁ through Xₙ and the Y-electrode lines Y₁ through Yₙ may comprise a transparent electrode line formed of a transparent conductive material, e.g., indium tin oxide (ITO), and a metal electrode line, which increases conductivity. A front dielectric layer 11 covers the X-electrode lines X₁ through Xₙ and the Y-electrode lines Y₁ through Yₙ. The protective layer 12, which may be a MgO layer, covers the front dielectric layer 11 and protects the panel 1 from a strong electric field. A plasma forming gas is hermetically sealed in a discharge space 14.

U.S. Pat. No. 5,541,618 discloses an address-display separation driving method for the PDP 1.

FIG. 2 is a block diagram showing a typical driving apparatus 2 for the PDP 1 shown in FIG. 1. Referring to FIG. 2, the typical driving apparatus 2 includes a video processor 26, a logic controller 22, an address driver 23, an X-driver 24, and a Y-driver 25. The video processor 26 converts an external analog video signal into a digital signal to generate an internal video signal that may include 8-bit red (R) video data, 8-bit green (G) video data, 8-bit blue (B) video data, a clock signal, a horizontal synchronizing signal, and a vertical synchronizing signal. The logic controller 22 generates drive control signals S_{A}, S_{Y}, and S_{X} in response to the internal video signal from the video processor 26.

The address driver 23, the X-driver 24, and the Y-driver 25 receive the drive control signals S_{A}, S_{X}, and S_{Y}, respectively, and then generate and apply driving signals to their corresponding electrode lines. In other words, the address driver 23 processes the address signal S_{A} to generate and apply a display data signal to the address electrode lines. The X-driver 24 processes the X-drive control signal S_{X} and applies the result of the processing to X-electrode lines. The Y-driver 25 processes the Y-drive control signal S_{Y} and applies the result of the processing to Y-electrode lines.

FIG. 3 is a timing chart illustrating a conventional method for driving the PDP 1 shown in FIG. 1. Referring to FIG. 3, to realize time-division grayscale display, a unit frame is divided into 8 subfields SF₁ through SF₈. The subfields SF₁ through SF₈ may comprise reset periods R₁ through R₈, address periods A₁ through A₈, and sustain periods S₁ through S₈, respectively.

Assuming that PDP brightness is proportional to a total length of the sustain periods S₁ through S₈ in the unit frame, lengths of the individual sustain periods S₁ through S₈ may be determined according to grayscale weights based on the brightness. Specifically, the total length of the sustain periods S₁ through S₈ in the unit frame is 255T, where T is a unit of time. Here, a sustain period Sₙ of an n-th subfield SFₙ is set to a time corresponding to 2ⁿ⁻¹. Accordingly, by appropriately selecting subfields to display from among the 8 subfields SF₁ through SF₈, a total of 256 grayscales, including a zero gray level where display is not performed in any subfield, may be represented.

FIG. 4 is a timing chart showing driving signals that may be applied to the electrode lines on the PDP 1 shown in FIG. 1 in a single subfield SFₙ shown in FIG. 3. In FIG. 4, a reference character S_{AR1 . . . ABm} denotes a driving signal applied to the address electrode lines A_{R1} through A_{Bm} shown in FIG. 1. A reference character S_{X1 . . . Xn} denotes a driving signal applied to the X-electrode lines X₁ through Xₙ shown in FIG. 1. Reference characters S_{Y1} through S_{Yn} denote driving signals applied to the Y-electrode lines Y₁ through Yₙ, respectively, shown in FIG. 1.

Referring to FIG. 4, during a reset period PR of the unit subfield SF, a voltage applied to the X-electrode lines X₁ through Xₙ increases from a ground voltage V_{G} to a first voltage Vₑ. During this time, the ground voltage V_{G} is applied to the Y-electrode lines Y₁ through Yₙ and the address electrode lines A_{R1} through A_{Bm}.

Next, the voltage applied to the Y-electrode lines Y₁ through Yₙ increases from the second voltage V_{S}, for example, 155 V, to a maximum voltage V_{SET}+V_{S}, for example, 355 V. During this time, the ground voltage V_{G} is applied to the X-electrode lines X₁ through Xₙ and the address electrode lines A_{R1} through A_{Bm}.

Next, the voltage applied to the Y-electrode lines Y₁ through Yₙ decreases from the second voltage V_{S} to the ground voltage V_{G} while the voltage applied to the X-electrode lines X₁ through Xₙ maintains the first voltage Vₑ. During this time, the ground voltage V_{G} is applied to the address electrode lines A_{R1} through A_{Bm}.

Accordingly, during a subsequent address period PA, display data signals are applied to the address electrode lines A_{R1} through A_{Bm}, and a scan signal having the ground voltage V_{G} is sequentially applied to the Y-electrode lines Y₁ through Yₙ, which are biased to a fourth voltage V_{SCAN}. Here, display data signals for selecting a discharge cell have a positive address voltage V_{A} and the ground voltage V_{G}. Applying these signals to the address and Y electrodes induces an address discharge, which forms wall charges in a corresponding discharge cell. However, wall charges are not formed in non-selected discharge cells. The first voltage Vₑ is applied to the X-electrode lines X₁ through Xₙ to accomplish more accurate and efficient address discharge.

During a subsequent sustain period PS, a sustain pulse having the second voltage V_{S} is alternately applied to the Y-electrode lines Y₁ through Yₙ and the X-electrode lines X₁ through Xₙ, thereby provoking display discharge in selected discharge cells.

FIG. 5 is a graph showing a number of sustain pulses versus brightness displayed on a PDP. Referring to FIG. 5, a curve Cr represents an actual relationship between a number of sustain pulses, Nₛ, and the displayed brightness L, and a line Ci represents an ideal relationship between them. A conventional driving method for a PDP may determine the number of sustain pulses Ns to apply in a frame based on the assumption that a linear relationship exists between that number and the brightness L to be displayed. Accordingly, during the frame's sustain periods, a predetermined number of sustain pulses Ns is applied to the Y electrodes lines Y₁ through Yₙ and the X-electrode lines X₁ through Xₙ. The number of sustain pulses applied in the individual sustain periods S₁ through S₈ may be obtained by dividing the number of sustain pulses Nₛ in the frame in a ratio between grayscale weights respectively corresponding to the lengths of the sustain periods S₁ through S₈.

However, in reality, as shown by the curve Cr in FIG. 5, the number of sustain pulses Ns and the displayed brightness L do not have a linear relationship with each other, which may be due to the PDP's structure and materials. This non-linear relationship may cause inaccurate grayscale display, such as non-linear grayscale display or inversion of a grayscale.

### SUMMARY OF THE INVENTION

The present invention provides a PDP driving method in which a number of applied sustain pulses has a linear relationship with brightness in a subfield.

Additional features of the invention will be set forth in the description which follows, and in part will be apparent from the description, or may be learned by practice of the invention.

The present invention discloses a method for driving a PDP including sustain electrode pairs, in which X-electrodes and Y-electrodes alternate with each other in parallel, and address electrodes, which cross the sustain electrode pairs, form display cells at intersections therebetween. The method includes processing a video signal to generate a frame, dividing the frame into a plurality of subfields having allocated grayscale weights, and applying a number of sustain pulses for each subfield to the sustain electrode pairs during a sustain period in each subfield. The number of sustain pulses for each subfield is determined such that a brightness produced by applying the number of sustain pulses for the subfield is linearly proportional to the subfield's allocated grayscale weight.

The present invention also discloses a method of driving a PDP including sustain electrode pairs, in which X-electrodes and Y-electrodes alternate with each other in parallel, and address electrodes, which cross the sustain electrode pairs, form display cells at intersections therebetween. The method includes processing a video signal to generate a frame, dividing the frame into a plurality of subfields having allocated grayscale weights, and applying a number of sustain pulses for each subfield to the sustain electrode pairs during a sustain period in each subfield. The applying includes obtaining a number of sustain pulses for the frame, obtaining numbers of sustain pulses for the respective subfields by dividing the number of sustain pulses for the frame in a ratio between the allocated grayscale weights determined by a ratio between numbers of sustain pulses for the respective subfields linearly proportional to brightnesses that are actually displayed by sustain discharges induced by the numbers of sustain pulses in the respective subfields, and generating a driving waveform to apply the numbers of sustain pulses for the respective subfields to the sustain electrode pairs in the respective subfields.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an internal perspective view showing a structure of a conventional surface discharge type triode PDP.

FIG. 2 is a block diagram showing a typical driving apparatus for the PDP shown in FIG. 1.

FIG. 3 is a timing chart showing a conventional method for driving the PDP shown in FIG. 1.

FIG. 4 is a timing chart showing driving signals applied to electrode lines on the PDP shown in FIG. 1 in a unit subfield shown in FIG. 3.

FIG. 5 is a schematic graph showing a number of sustain pulses versus brightness displayed on a PDP.

FIG. 6 is a schematic flowchart showing a method for driving a PDP according to an exemplary embodiment of the present invention.

FIG. 7 is a schematic graph showing the method shown in FIG. 6.

FIG. 8 is a schematic graph showing a method of driving a PDP according to an exemplary embodiment of the present invention.

FIG. 9 is a block diagram showing an apparatus for performing the driving method according to the exemplary embodiments of FIG. 6 and FIG. 8.

FIG. 10 is a block diagram showing a logic controller for implementing the apparatus shown in FIG. 9.

### DETAILED DESCRIPTION OF THE ILLUSTRATED EMBODIMENTS

The present invention will now be described more fully with reference to the accompanying drawings, in which exemplary embodiments of the invention are shown. Like reference numerals in the drawings denote like elements.

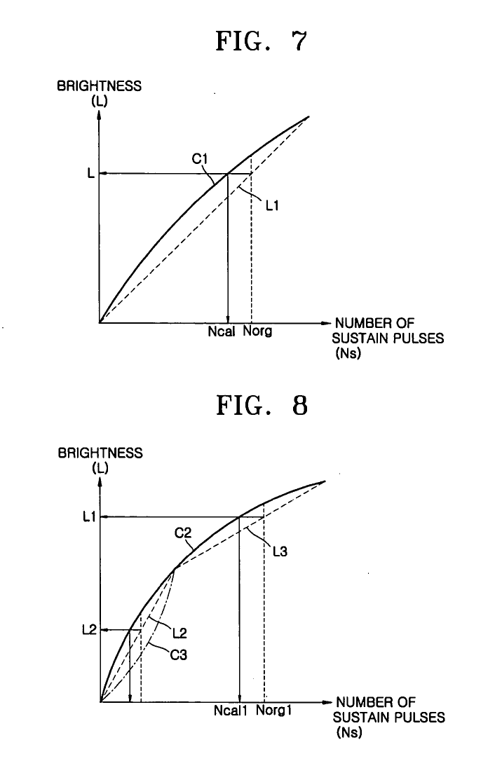

FIG. 6 is a flowchart showing a PDP driving method 200 according to an exemplary embodiment of the present invention. FIG. 7 is a graph illustrating a part of the method shown in FIG. 6.

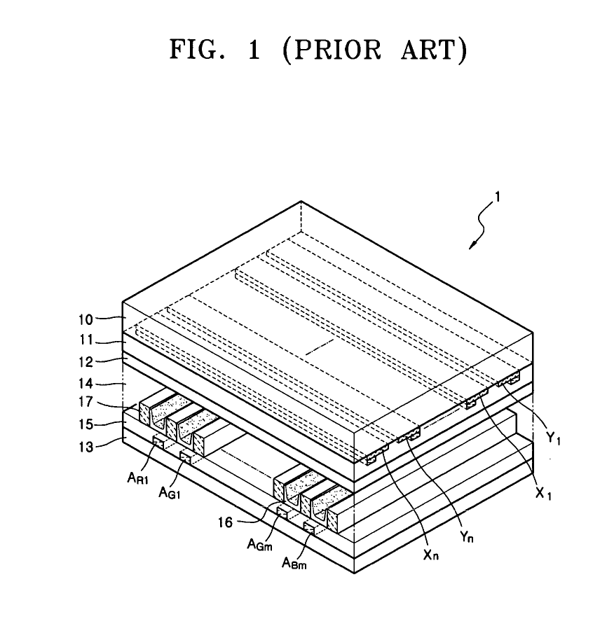

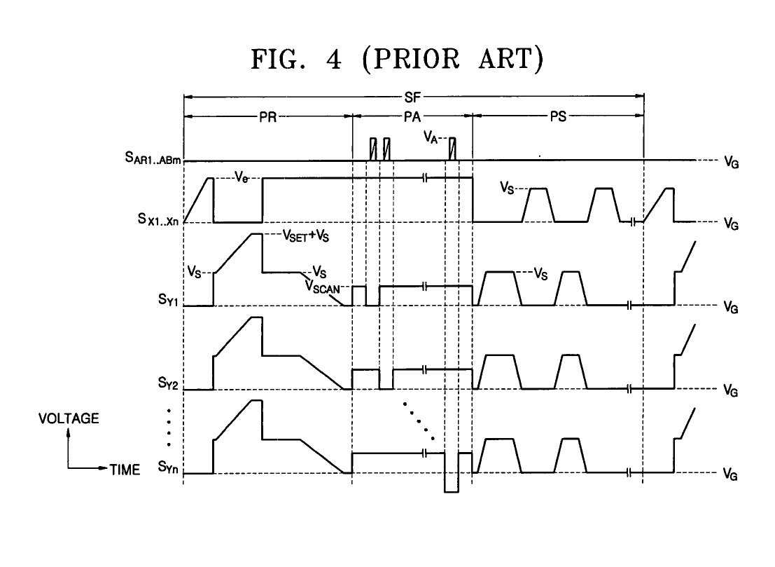

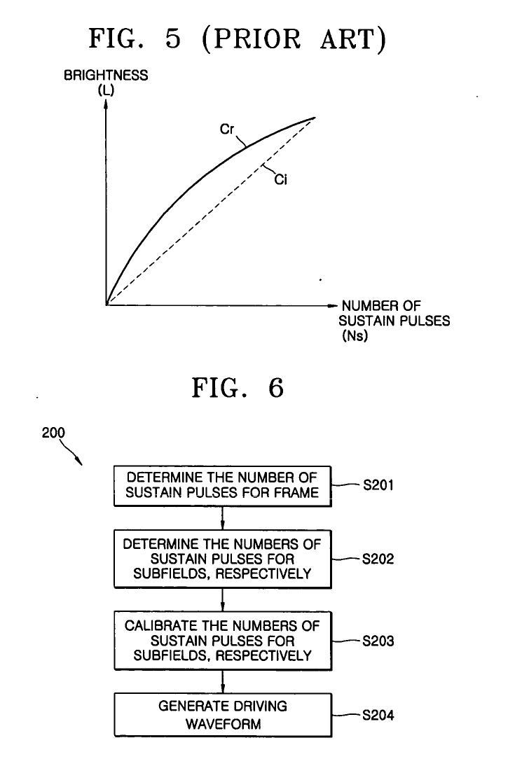

The PDP includes sustain electrode line pairs, in which the X-electrode lines X₁ through Xₙ and the Y-electrode lines Y₁ through Yₙ shown in FIG. 1 are alternately arranged, and the address electrode lines A_{R1} through A_{Bm} shown in FIG. 1 cross the sustain electrode line pairs, thereby forming cells at intersections therebetween. In the PDP driving method 200, an external video signal is processed to generate a frame. The frame is divided into a plurality of the subfields SF1 through SF8, having unique grayscale weights, to perform grayscale display. The individual subfields SF1 through SF8 may comprise the reset periods R1 through R8, the address periods A1 through A8, and the sustain periods S1 through S8, respectively. The unique grayscale weights may be determined according to a desired brightness to be displayed by cells on the PDP, and a number of sustain pulses for each subfield SF1 through SF8 may be proportional to a brightness produced by sustain discharge corresponding to the number of sustain pulses. During the sustain period PS in the subfield SF shown in FIG. 4, the number of sustain pulses determined for the subfield SF are applied to the sustain electrode line pairs.

The PDP driving method 200 includes determining a number of sustain pulses Ns for a frame in operation S201, determining nominal numbers of sustain pulses Norgₙ (where n=1, . . . , 8) for subfields, respectively, in the frame in operation S202, obtaining calibrated numbers of sustain pulses Ncalₙ (where n=1, . . . , 8) for the respective subfields in operation S203, and generating a driving waveform in operation S204.

In operation S201, the number of sustain pulses Ns for the frame is a number of sustain pulses needed for a sustain discharge in the frame. In operation S202, the nominal numbers of sustain pulses Norgₙ for the respective subfields may be obtained by dividing the number of sustain pulses Ns in a ratio between grayscale weights 2ⁿ⁻¹ (where n=1, . . . , 8) allocated to the respective subfields. In operation S203, the calibrated numbers of sustain pulses Ncalₙ (n=1, . . . , 8) for the respective subfields correspond to desired brightnesses L to be respectively displayed by the nominal numbers of sustain pulses Norgₙ for the respective subfields. In operation 5204, to display a desired brightness L, a generated driving waveform applies the calibrated number of sustain pulses Ncal for each subfield to the sustain electrode line pairs.

In exemplary embodiments of the present invention, a frame is divided into 8 subfields, i.e., n=1, . . . , 8. However, the present invention is not restricted thereto, and the frame may have more or less than 8 subfields.

In operation S201, the number of sustain pulses Ns for the frame may be determined by estimating a frame load ratio, which is a ratio of a number of display cells to be turned on in the frame to a total number display cells on the PDP. The number of sustain pulses Ns, which may be in inverse proportion to the estimated frame load ratio, may obtained from an automatic power control table.

In operation S202, the nominal numbers of sustain pulses Norgₙ for the respective subfields may be determined by dividing the number of sustain pulses Ns for the frame in the ratio between grayscale weights 2ⁿ⁻¹ (where n=1, . . . , 8) allocated to the respective subfields. A nominal table may be made having nominal numbers of sustain pulses Norgₙ (where n=1, . . . , 8) linearly allocated to each grayscale weight 2ⁿ⁻¹. The nominal numbers of sustain pulses Norgₙ may be obtained from the nominal table.

In operation S203, the calibrated numbers of sustain pulses Ncalₙ (where n=1, . . . , 8) are the numbers of sustain pulses actually needed to display a desired brightness L corresponding to the nominal numbers of sustain pulses Norgn. A calibration table in which the calibrated numbers of sustain pulses Ncalₙ actually needed to respectively display the desired brightnesses L corresponding to the respective nominal numbers of sustain pulses Norgₙ are respectively allocated to the desired brightnesses L corresponding to the respective nominal numbers of sustain pulses Norgn may be made. The calibrated numbers of sustain pulses Ncalₙ may be obtained from the calibration table.

FIG. 7 shows the operational concepts of S202 and S203. A line L1 represents an ideal relationship between a number of sustain pulses Norg and a brightness L for a subfield, in which the number of sustain pulses Norg is linearly proportional to the brightness L. A curve C1 represents a real relationship between a number of sustain pulses Ncal and the brightness L for the subfield, in which the number of sustain pulses Ncal is not linearly proportional to the brightness L.

In an exemplary embodiment of the present invention, the nominal numbers of sustain pulses Norgn for the respective subfields may be determined by dividing the number of sustain pulses Ns for the frame in the ratio between the grayscale weights 2ⁿ⁻¹ allocated to the respective subfields. This is illustrated by the line L1 representing the linear relationship between a number of sustain pulses and a brightness for a subfield. However, as shown by curve C1, there may be a difference between a brightness that linearly corresponds to a number of sustain pulses and a brightness that is actually displayed by the number of sustain pulses. Consequently, when applying the number sustain pulses corresponding to the brightness in the line L1, a desired grayscale in the frame, which is represented by the sum of the brightnesses in the respective subfields, may not actually be displayed.

Accordingly, a real relationship between desired brightnesses L and applied numbers of sustain pulses may be obtained, such as the curve C1, thereby enabling a calibration of the nominal number of sustain pulses Norg based on the real relationship represented by the curve C1. In detail, the nominal number of sustain pulses Norg corresponding to a grayscale weight for the desired brightness L may be obtained from the nominal table formed by the line L1. The calibrated number of sustain pulses Ncal corresponding to the desired brightness L may be obtained from the calibration table formed by the curve C1.

As shown in FIG. 7, the calibrated number of sustain pulses Ncal corresponding to the desired brightness L from the curve C1 is usually less than the nominal number of sustain pulses Norg corresponding to the desired brightness L from the line L1. In this situation, since power consumption corresponding to the calibrated number of sustain pulses Ncal may be less than power consumption corresponding to the nominal number of sustain pulses Norg, a power problem may not occur.

In operation S204, a driving waveform is generated to apply the calibrated number of sustain pulses Ncal to the sustain electrode line pairs, thereby displaying the desired brightness L.

In displaying a frame according to exemplary embodiments of the present invention, a grayscale weight for a brightness to be displayed in the frame may be determined. Grayscale weights for respective subfields included in the frame may be obtained from the determined grayscale weight for the frame. Referring to the grayscale weights for the respective subfields, subfields that will be sustain discharged, and those that will not, are determined. In the frame, address discharge may be provoked only in those address periods corresponding to the subfields that will be sustain discharged.

A method for driving a PDP according to another exemplary embodiment of the present invention determining a number of sustain pulses Ns for a frame, obtaining numbers of sustain pulses Ncalₙ (n=1, . . . , 8) for subfields, respectively, included in the frame, and generating a driving waveform.

The number of sustain pulses Ns for the frame is determined based on a number of sustain pulses provoking sustain discharge in the frame. The driving waveform is generated to apply a number of sustain pulses Ncalₙ to the sustain electrode line pairs to display a desired brightness L for each subfield.

The step of obtaining numbers of sustain pulses Ncalₙ for the subfields, respectively, may include operation S202, in which the nominal numbers of sustain pulses Norgₙ for the respective subfields are obtained, and operation S203, in which the calibrated numbers of sustain pulses Ncalₙ for the respective subfields are obtained.

The numbers of sustain pulses Ncalₙ for the respective subfields may be obtained by dividing the number of sustain pulses Ns for the frame in a ratio between grayscale weights for the respective subfields determined by a ratio between numbers of sustain pulses linearly proportional to the brightnesses L that are actually displayed by sustain discharges induced by the numbers of sustain pulses. A table may be made having a number of sustain pulses linearly proportional to a brightness corresponding to a grayscale weight for each subfield allocated to the brightness. A number of sustain pulses corresponding to a brightness corresponding to a grayscale for each subfield may be obtained from the table. In other words, operation S202, in which the nominal numbers of sustain pulses Norgₙ (where n=1, . . . , 8) for the respective subfields are obtained, and operation S203, in which the calibrated numbers of sustain pulses Ncalₙ for the respective subfields are obtained, may be integrated into a single operation.

FIG. 8 is a graph showing a method for driving a PDP according to another exemplary embodiment of the present invention. The embodiment shown in FIG. 8 is similar to the embodiment shown in FIG. 6 and FIG. 7 with the following exception. In the exemplary embodiment shown in FIG. 8, nominal numbers of sustain pulses Norgₙ (where n=1, . . . , 8) for respective subfields in a frame may be obtained by dividing a number of sustain pulses Ns for the frame in a ratio between grayscale weights 2ⁿ⁻¹ (where n=1, . . . , 8) allocated to the respective subfields in operation S202 shown in FIG. 6. A nominal table may be made having the nominal numbers of sustain pulses Norgₙ linearly allocated to the grayscale weights 2ⁿ⁻¹. The nominal table includes two or more sections having different slopes in a linear proportion. In other words, there is a linearly proportional relationship having at least two different slopes between grayscale weights and the numbers of sustain pulses for the respective subfields.

According to the exemplary embodiment shown in FIG. 8, when calibration is performed differently for subfields requiring small and large numbers of sustain pulses, low grayscale display may be improved without manipulating a gamma curve. In other words, the low grayscale display may be improved by calibrating based on a line L2 or a curve C3 in a low grayscale section.

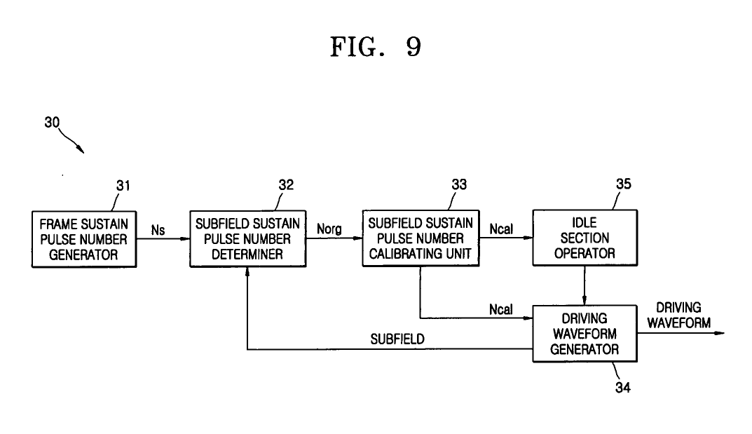

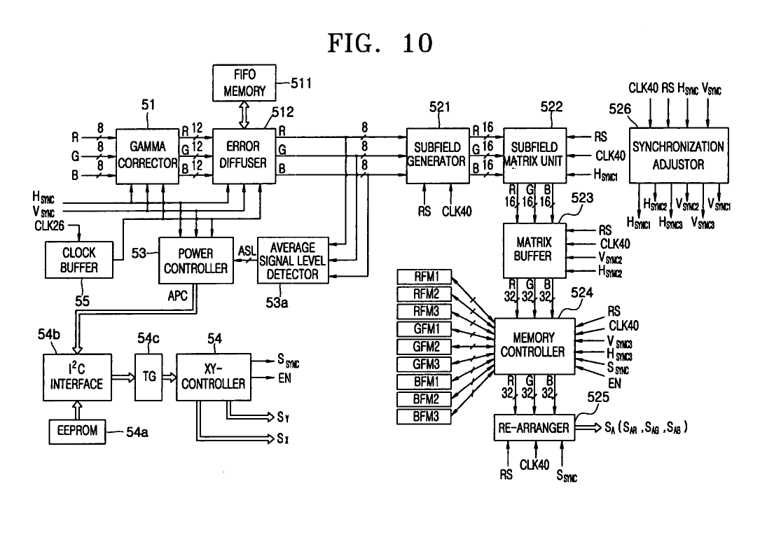

FIG. 9 is a block diagram showing an apparatus for performing the methods according to the exemplary embodiments shown in FIG. 6 and FIG. 8. Referring to FIG. 9, an apparatus 30 for driving a PDP may include a frame sustain pulse number generator 31, a subfield sustain pulse number determiner 32, a subfield sustain pulse number calibrating unit 33, and a driving waveform generator 34.

The frame sustain pulse number generator 31 determines a number of sustain pulses Ns for a frame needed to provoke an appropriate sustain discharge in the frame. The subfield sustain pulse number determiner 32 determines a nominal number of sustain pulses Norg for a current subfield by dividing the number of sustain pulses Ns for the frame in a ratio between numbers of sustain pulses proportional to grayscale weights for the respective subfields. The subfield sustain pulse number calibrating unit 33 obtains a calibrated number of sustain pulses Ncal that are required to actually display a desired brightness based on the nominal number of sustain pulses Norg for the current subfield. The driving waveform generator 34 generates a driving waveform to apply the calibrated number of sustain pulses Ncal to sustain electrode line pairs in order to display the desired brightness.

The apparatus 30 may further include an idle section operator 35, which processes an idle section in which a display signal is not generated when the number of sustain pulses Ns for a frame changes within a predetermined vertical synchronizing signal.

FIG. 10 is a block diagram showing a logic controller for implementing the apparatus 30 shown in FIG. 9. Referring to FIG. 10, the logic controller may include a clock buffer 55, a synchronization adjustor 526, a gamma corrector 51, an error diffuser 512, a first-in first-out FIFO memory 511, a subfield generator 521, a subfield matrix unit 522, a matrix buffer 523, a memory controller 524, frame memories RFM1 through BFM3, a re-arranger 525, an average signal level detector 53a, a power controller 53, an electrically erasable programmable read-only memory EEPROM 54a, an I²C interface 54b, a timing-signal generator TG 54c, and an XY-controller 54.

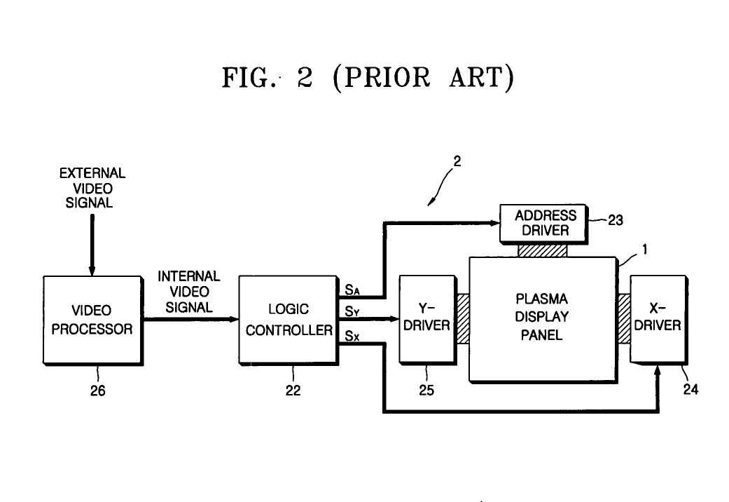

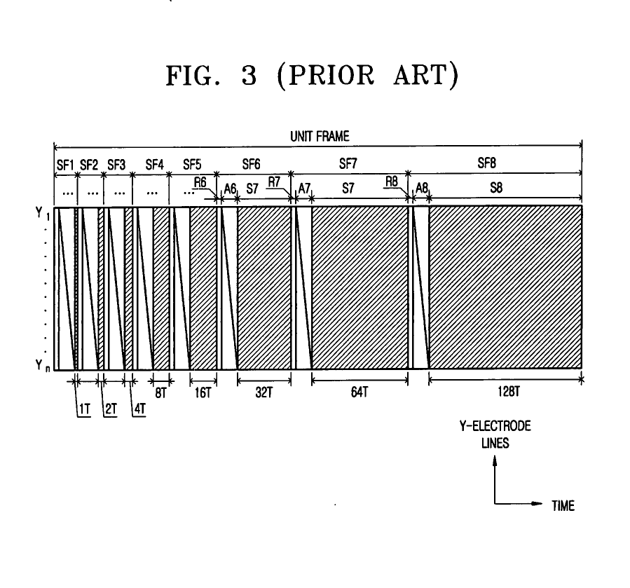

The clock buffer 55 converts a 26 MHz clock signal CLK26, which may be inputted from the video processor 26 shown in FIG. 2, into a 40 MHz clock signal CLK40. The synchronization adjustor 526 receives the 40 MHz clock signal CLK40, an external reset signal RS, and horizontal and vertical synchronizing signals H_{SYNC}, V_{SYNC} from the video processor 26. The synchronization adjustor 526 outputs horizontal synchronizing signals H_{SYNC1}, H_{SYNC2}, and H_{SYNC3}, and vertical synchronizing signals V_{SYNC1}, V_{SYNC2}, and V_{SYNC3}, which may be obtained by delaying the horizontal and vertical synchronizing signals, H_{SYNC}, V_{SYNC}, respectively, by predetermined numbers of clock pulses.

R, G, and B video data input into the gamma corrector 51 may have a non-linear reverse input/output characteristic to compensate for a cathode-ray tube's non-linear input/output characteristic. Accordingly, the gamma corrector 51 may process the R, G, and B video data to have a linear input/output characteristic. The error diffuser 512 moves a position of a most significant bit (MSB), which is a border bit of the R, G, and B video data, using the FIFO memory 511 to reduce a data transmission error.

The subfield generator 521 converts 8-bit R, G, and B video data to have a number of bits corresponding to a number of subfields included in a single frame. For example, when a single frame includes 14 subfields to display a grayscale, the subfield generator 521 converts the 8-bit R, G, and B video data into 14-bit R, G, and B video data and adds invalid data having a value of “0” to the 14-bit R, G, and B video data as an MSB and a least significant bit (LSB), thereby outputting 16-bit R, G, and B video data.

The subfield matrix unit 522 rearranges the 16-bit R, G, and B video data including data for different subfields to simultaneously output data for the same subfield. The matrix buffer 523 processes the 16-bit R, G, and B video data to output 32-bit R, G, and B video data.

The memory controller 524 includes a red memory controller that controls the three frame memories RFM1, RFM2, and RFM3, a green memory controller that controls the three frame memories GFM1, GFM2, and GFM3, and a blue memory controller that controls the three frame memories BFM1, BFM2, and BFM3. The memory controller 524 continuously outputs frame data in units of frames to the re-arranger 525. A reference character EN denotes an enable signal that is generated by the XY-controller 54 and input to the memory controller 524 to control its data output. A reference character S_{YNC} denotes a slot synchronizing signal that is generated by the XY-controller 54 and input to the memory controller 524 and the re-arranger 525 to respectively control their data output and input in units of 32-bit slots. The re-arranger 525 rearranges the 32-bit R, G, and B video data from the memory controller 524 in accordance with an input format for the address driver 23 shown in FIG. 2.

Meanwhile, the average signal level detector 53a detects an average signal level ASL from the 8-bit R, G, and B video data received from the error diffuser 512 in units of frames and transmits the ASL to the power controller 53. The power controller 53 generates discharge number control data APC corresponding to the ASL, thereby performing automatic power control to provide uniform power consumption in each frame. A load ratio indicates an average of load ratios in respective subfields in one frame. A load ratio in each subfield is a ratio of a number of display cells to be turned on to the total number of display cells on the PDP.

The EEPROM 54a stores timing control data in accordance with a driving sequence of the X-electrode lines X₁ through Xₙ and the Y-electrode lines Y₁ through Yₙ shown in FIG. 1. The discharge number control data APC from the power controller 53 and the timing control data from the EEPROM 54a are input to the TG 54c via the I²C interface 54b, and the TG 54c generates a timing-signal. The XY-controller 54 operates according to the timing-signal from the TG 54c and outputs X and Y driving control signals S_{X}, S_{Y}.

In an exemplary embodiment of the present invention, the power controller 53 may perform functions performed in the frame sustain pulse number generator 31, the subfield sustain pulse number determiner 32, and the subfield sustain pulse number calibrating unit 33 shown in FIG. 9. Additionally, the XY-controller 54 may perform functions performed in the idle section operator 35 and the driving waveform generator 34 shown in FIG. 9.

According to the present invention, an applied number of sustain pulses has a linear relationship with a desired brightness in a subfield, a grayscale may be accurately displayed.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents

1. A method for driving a plasma display panel (PDP) including sustain electrode pairs, in which X-electrodes and Y-electrodes are alternately arranged with each other, and address electrodes, which cross the sustain electrode pairs, thereby forming display cells at intersections therebetween, the method comprising:
processing a video signal to generate a frame;
dividing the frame into a plurality of subfields having allocated grayscale weights; and
applying a number of sustain pulses for a subfield to the sustain electrode pairs during a sustain period of the subfield,
wherein the number of sustain pulses for the subfield is determined such that a brightness produced by applying the number of sustain pulses for the subfield is linearly proportional to the allocated grayscale weight of the subfield.

2. The method of claim 1, wherein the applying comprises:
obtaining a number of sustain pulses for the frame;
obtaining nominal numbers of sustain pulses for respective subfields of the frame by dividing the number of sustain pulses for the frame in a ratio between the allocated grayscale weights of the respective subfields;
obtaining calibrated numbers of sustain pulses for the respective subfields corresponding to desired brightnesses to be respectively displayed by the nominal numbers of sustain pulses for the respective subfields; and
generating a driving waveform to apply the calibrated numbers of sustain pulses for the respective subfields to the sustain electrode pairs in sustain periods of the respective subfields.

3. The method of claim 2, wherein obtaining a number of sustain pulses for the frame comprises:
estimating a load ratio of a number of display cells to be turned on to a total number of display cells on the PDP for each frame; and
determining the number of sustain pulses for the frame to be in inverse proportion to the estimated load ratio.

4. The method of claim 3, wherein determining the number of sustain pulses for the frame comprises:
making an automatic power control table in which a number of sustain pulses is allocated to a load ratio such that the number of sustain pulses is in inverse proportion to the load ratio; and
obtaining the number of sustain pulses for the frame corresponding to the estimated load ratio for the frame from the automatic power control table.

5. The method of claim 2, wherein obtaining nominal numbers of sustain pulses for the respective subfields comprises:
making a nominal table in which the nominal numbers of sustain pulses for the respective subfields are allocated to the respective allocated grayscale weights of the subfields such that the nominal numbers of sustain pulses for the respective subfields are linearly proportional to the allocated grayscale weights of the subfields; and
obtaining nominal numbers of sustain pulses for the respective subfields corresponding to allocated grayscale weights of subfields from the nominal table.

6. The method of claim 2, wherein in the operation of obtaining nominal numbers of sustain pulses for respective subfields, a linear relationship having at least two different slopes exists between the allocated grayscale weights for the respective subfields and the numbers of sustain pulses for the respective subfields.

7. The method of claim 2, wherein obtaining calibrated numbers of sustain pulses for the respective subfields comprises:
making a calibration table in which the calibrated numbers of sustain pulses actually needed to respectively display the desired brightnesses corresponding to the respective nominal numbers of sustain pulses are respectively allocated to the desired brightnesses corresponding to the respective nominal numbers of sustain pulses; and
obtaining calibrated numbers of sustain pulses corresponding to a nominal number of sustain pulses for each subfield from the calibration table.

8. The method of claim 2, wherein the calibrated numbers of sustain pulses are less than the nominal numbers of sustain pulses for the respective subfields.

9. A method of driving a plasma display panel (PDP) including sustain electrode pairs, in which X-electrodes and Y-electrodes alternate with each other in parallel, and address electrodes, crossing the sustain electrode line pairs to form display cells at intersections therebetween, the method comprising:
processing a video signal to generate a frame;
dividing the frame into a plurality of subfields having allocated grayscale weights; and
applying a number of sustain pulses for a subfield to the sustain electrode pairs during a sustain period of the subfield,
wherein the applying comprises:
obtaining a number of sustain pulses for the frame;
obtaining numbers of sustain pulses for respective subfields by dividing the number of sustain pulses for the frame in a ratio between the allocated grayscale weights of the respective subfields determined by a ratio between numbers of sustain pulses for the respective subfields linearly proportional to brightnesses that are actually displayed by sustain discharges induced by the numbers of sustain pulses in the respective subfields; and
generating a driving waveform to apply the numbers of sustain pulses for the respective subfields to the sustain electrode pairs in the respective subfields.

10. The method of claim 9, wherein obtaining numbers of sustain pulses for respective subfields comprises:
making a table in which a number of sustain pulses linearly proportional to a brightness corresponding to an allocated grayscale weight for each subfield is allocated to the brightness; and
obtaining a number of sustain pulses corresponding to a brightness corresponding to an allocated grayscale weight for each subfield from the table.
